(19) United States
(12) Patent Application Publication
(10) Pub. No.: US 2023/0059793 A1
(43) Pub. Date: Feb. 23, 2023

(54) SYSTEM AND METHOD FOR NON-PROGRAMMATICALLY CONSTRUCTING SOFTWARE SOLUTIONS ON CONFIGURABLE COMPUTING PLATFORM

(71) Applicant: Unilog Content Solutions, LLC, Wayne, PA (US)

(72) Inventors: Manoo Urs, San Jose, CA (US); Raghunath Kaveeshwaram, Bengaluru (IN); Kiran K. Grandhi, Bengaluru (IN); Noah Frederic Kays, Camas, WA (US)

(21) Appl. No.: 17/753,257

(22) PCT Filed: Aug. 31, 2020
(86) PCT No.: PCT/US2020/048828

§ 371 Date: Feb. 25, 2022

Related U.S. Application Data
(60) Provisional application No. 62/893,222, filed on Aug. 29, 2019.

(51) Int. Cl. G06F 8/34; G06F 8/20

(52) U.S. Cl. CPC G06F 8/34; G06F 8/20

(57) ABSTRACT

A visual software development system and method in which a user can graphically build a design or software solution for execution on a configurable computing platform without having to write software code and which can use elements of one or more modules of the configurable computing platform and/or one or more cooperating disparate software systems, data sources, and computing networks. The system includes one or more adapters that interrogate interfaces of the software platform that the software system or systems was built in accordance with and generate descriptions that the user can then incorporate into the design. The descriptions can be represented graphically for the user with icons in an integrated development environment (IDE), and the user can build the design by dragging or otherwise selecting descriptions to be used and connecting them together to graphically represent the flow of information or communication of events among the descriptions.

### CROSS-REFERENCES TO RELATED APPLICATIONS

This application claims priority to, and incorporates by reference herein in its entirety, pending U.S. Provisional Patent Application Ser. No. 62/893,222, filed Aug. 29, 2020.

### BACKGROUND OF THE INVENTION

### Field of the Invention

The present invention relates generally to graphical programming and visual software development and, more specifically, to building solutions integrating disparate/collaborating software systems and/or data sources without programming, such software solutions being deployable on a configurable computing platform.

### Description of the Related Art

Creating software is generally known to be technically challenging, time consuming, and expensive. Enterprise software products and solutions can have thousands of objects and source code modules. Software tools are becoming more and more similar to the CAD tools used in other fields of design and construction. Illustratively, the Integrated Development Environment (IDE) is an exemplary standard foundation for modern Rapid Application Development (RAD) tools akin to CAD tools. Examples of software IDEs include Borland Software Corporation's DELPHI® and JBUILDER®, Sybase Inc.'s POWERBUILDER®, Microsoft Corporation's VISUAL BASIC® and MICROSOFT VISUAL STUDIO®, IBM Corporation's VISUAL AID®, and many others.

Microsoft's VISUAL STUDIO® IDE includes a number of graphical elements. The Design Surface is where objects can be assembled into a new software application, library, or service. The Solution Explorer is a hierarchical explorer of the objects and software deliverables that comprise the solution. The Toolbox contains a catalog of reusable objects that can be dragged onto a design surface to facilitate the assembly. The Property Grid that shows and allows the manipulation of the property values of the currently selected object. The Source Code editor for programmers to write source code, and may also show the source code that is generated in response to user manipulation of the properties of objects with the property grid, and the placing of additional objects from the toolbox onto a design surface. Operatively, a compiler can consume the source code created within the environment, both by programmers and generated by the IDE, in order to produce the modules that comprise a new software program.

The typical IDEs' graphical designers are usually limited to the creation of the Graphical User Interface (GUI). Unlike Electronic CAD, typical IDEs require programmers to author source code to define the software's algorithms.

More recent IDEs have included the ability to define integration and logic algorithms graphically in a manner similar to Electronic CAD. Known as “Visual Programming”, these tools use a graphical diagram where nodes are visually connected. The nodes may represent a variable, a function, an object, or an operator. These tools may generate source code that is compiled or a script that is interpreted. Visual Programming is known to greatly reduce the time and complexity of software construction. National Instruments Corporation's LABVIEW® is an example of a well-known Visual Programming environment utilized in the instrumentation and measurement market.

Application Integration tools enable the construction of new software solutions that integrate existing software systems. These tools are known to use Connectors, also known as Drivers or Adapters, to provide software routines for intelligent interaction with existing software systems. Connectors provide a common Application Program Interface (API) that maps to an existing system's “Open” APis. Open is the term generally used to mean “for public use.” For this definition, API may include a software system's data stores. Open APis may be software system specific, such as for Siebel or Clarify, CRM vendors with rich software development kits. OpenAPis may also be standards, such as Open Database Connectivity (ODBC). In this manner, program-mers can master the common API, and use Connectors to interact with multiple APis without needing to master the interface details of the APis.

When a software system does not provide an Open API, a Connector can be difficult or impossible to build. These software systems are called “closed.” Many times, legacy software systems, especially those built by a business' internal staff, are closed. The large number of closed software systems is well known to be the most significant issue confronting software integration. As a result, while many major software systems have Connectors, most software systems do not. iWay Software, a well-known provider of Connectors to commercial software systems, has less than 300 Connectors as of this writing. This is just a tiny fraction of software systems in existence.

When a family of software systems or hardware devices exist that provide common functionality but are manufactured by multiple vendors, standard APIs are defined, typically by a major vendor or a consortium of vendors. A more recent form of Connector is one where a user interface is provided for interrogating a software system's Open APIs to construct a new API in a preferred form.

This type of Connector is typically called an Adapter. iWay Software allows for Adapters to be constructed that may combine many elements of a complex software system, such SAP or Clarify, to produce a Java or Web Service API. This not only shields programmers from the technical details of the target systems APIs but allows them to dynamically define the new API customized to their needs. This eliminates the common problem of standards that become out of date.

While Adapters overcome some of the issues with Connectors or Drivers, the production of a programmatic API limits its use to programmers with tools compatible with the software platforms an Adapter chooses to support. Additionally, Adapters of the prior art are limited to Open APIs, and therefore do not overcome the issue of the majority of software systems that are closed.

Visual Programming tools of the prior art have significant limitations in their ability to integrate with existing software systems. Additionally, a Visual Programming environment may be able to dynamically integrate to existing software systems when the software system offers a programmatic interface compatible with the Visual Programming environment, such as a tool developed for the MICROSOFT WINDOWS® platform may be able to integrate with a software program that offers a COM API. Not only does this require knowledge of programmatic interfaces beyond that of many users, it limits the available software programs to those that offer a compatible programmatic interface. The number of software programs that offer incompatible programmatic interfaces is far greater than those that do, and therefore strictly limits the number of available compatible programs.

A Visual Programming tool may use an Adapter that provides a compatible programmatic interface, but this would not overcome the limitations Adapters impose on integration with open systems.

Due to these limitations, Visual Programming tools of the prior art have been limited to small exclusive domains where extensive concerted efforts have been made to create a catalog of reusable components. The majority of new software solutions are therefore still manually created by programmers at great expense, time, and risk. The present invention addresses these problems and deficiencies and others to allow for a visual programmatic framework for use on a configurable computing platform that enables the efficient creation of end-use applications that requires less computing resources (processing cycles of the computer hardware, less network utilization for interaction with cooperating databases) as well as optimizes memory allocation using various data sources and executables in the manner described below.

### SUMMARY OF THE INVENTION

The present invention relates to a visual software development system and method in which a user can graphically build a design or software solution for execution on a configurable computing platform without having to write software code and which can use elements of one or more modules of the configurable computing platform and/or one or more cooperating disparate software systems, data sources, and computing networks. The system includes one or more adapters that interrogate interfaces of the software platform that the software system or systems was built in accordance with and generate descriptions that the user can then incorporate into the design. The descriptions can be represented graphically for the user with icons in an integrated development environment (IDE), and the user can build the design by dragging or otherwise selecting descriptions to be used and connecting them together to graphically represent the flow of information or communication of events among the descriptions.

Elements of two or more software systems of disparate technologies or platforms can be used together in the same design by providing an adapter suited to each technology. For example, a first adapter can be provided that is associated with World Wide Web (“Web”) technology, and a second adapter can be provided that is associated with Microsoft Windows technology. The user can cause each adapter to interrogate the interfaces and functionality of an application program or other software system belonging to the associated platform. For example, the user can cause a Web adapter to interrogate the user interface of a Web browser such as Internet Explorer and cause a Microsoft Windows adapter to interrogate the user interface of a calculator program, such as the familiar calculator utility or “accessory” that has commonly been provided along with the Windows operating system on essentially every Windows-based computer. Each adapter produces one or more descriptions that describe one or more elements of the application program it interrogated. Thus, in this example, without writing any software code, a user can build a design in which the Calculator communicates with Internet Explorer. A loader is also included, through which the user can cause the algorithm defined by the design to be executed or effected. For example, the algorithm can be that data gathered from the Web via the browser is input to the Calculator, and the Calculator performs some simple numerical calculation upon the data.

In an illustrative embodiment, herein described virtual software development systems, tools, and methods may be used to generate one or more software modules representative of one or more e-commerce catalogs for use as part of a robust e-commerce SaaS computing platform operative to allow for expedited design and deployment of large scale e-commerce storefronts having robust customization as well as controls over data element of larger data sets. In an illustrative implementation, the herein describe systems and methods can avail for the creation of different programmatic environments such that in the e-commerce embodiment illustration, multiple data development environments inclusive but not limited to catalogs and workspaces are availed. Illustratively, the catalogs can represent a primary collection of data items ready for long-term exports to other cooperating software modules such that the exports can be stratified on a per export channel basis, per export system basis or as a collection of customized data. Such catalogs can be illustratively operative to inherit data from other data sources such as parent catalogs and such catalogs may be illustratively updated through one or more other cooperating environments such as workspaces. Illustratively, the workspace environment may be operative to act as software module to edit data items, reviewing updates of new data items or environment features, and/or to allow for the publishing of approved changes to an illustrative parent catalog. In deploying the herein described features of the virtual non-programmatic virtual software development systems and methods, the rapid deployment, in terms of reduced time to go-live, reduced resources, and ease of configuration through the virtualized software development tool of complex e-commerce platforms having complicated data element relationships and associations can be achieved.

The straightforward if not trivial example of a calculator program communicating with a Web browser is intended merely for purposes of illustrating the power and flexibility the invention can provide to a user. However, in another example, a businessperson with little or no programming knowledge whose job involves using a first application program to process product orders, a second application program that controls shipping, and a third application program that produces sales reports for management personnel could use the invention to integrate functions or elements of the three programs in a manner that reduces a user's need to switch among the three programs, import data from one program to another, and otherwise use the programs individually. The invention allows such a user to integrate such programs in an automated manner into a unitary design of the type described above, such that the user need only execute and interact with the design to use disparate elements of the application programs or other software systems that are included in the design.

### BRIEF DESCRIPTION OF THE DRAWINGS

FIG. 1 is block diagram of a computer system on which software embodying the present invention can be executed and used.

FIG. 2 is a block diagram of an exemplary data model in accordance with the present invention.

FIG. 3 is a block diagram of a system in accordance with an exemplary embodiment of the present invention.

FIG. 4 is a block diagram showing exemplary components of an exemplary data model in accordance with the present invention.

FIG. 5 is a block diagram showing an illustrative deployment of an exemplary data model in accordance with the present invention.

FIG. 6 is a block diagram showing an illustrative deployment of a data model for use in an illustrative e-commerce embodiment in accordance with the present invention.

FIG. 7 is a block diagram showing an illustrative processing flow for data processed on an illustrative e-commerce embodiment in accordance with the present invention.

### DETAILED DESCRIPTION

### System Overview

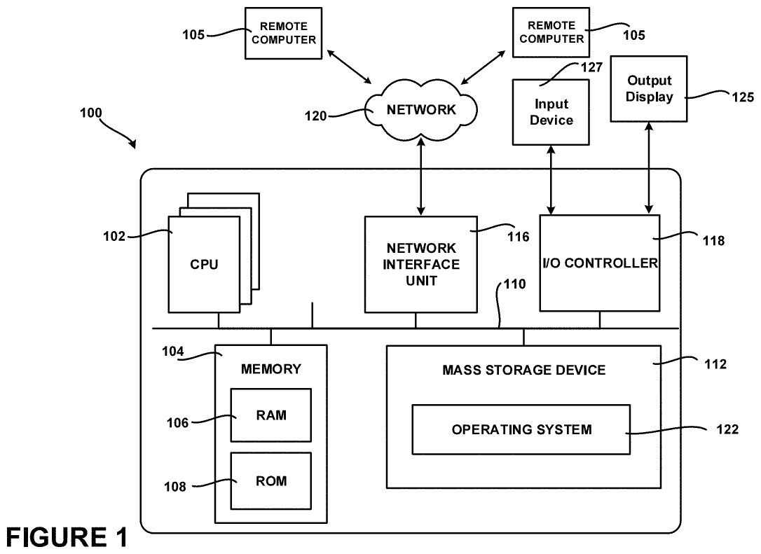

FIG. 1 is a computer architecture diagram showing an illustrative computer hardware and software architecture for a computing device that can operatively execute as described by the herein described systems and methods. In particular, the architecture contemplated in FIG. 1 can be utilized to implement a server computer, mobile phone, an e-reader, a smartphone, a desktop computer, an AR/VR device, a tablet computer, a laptop computer, or another type of computing device.

The computer 100 illustrated in FIG. 1 includes a central processing unit 102 (“CPU”), a system memory 104, including a random-access memory 106 (“RAM”) and a read-only memory (“ROM”) 108, and a system bus 110 that couples the memory 104 to the CPU 102. A basic input/output system (“BIOS” or “firmware”) containing the basic routines that help to transfer information between elements within the computer 100, such as during startup, can be stored in the ROM 108. The computer 100 further includes a mass storage device 112 for storing an operating system 122, application programs, and other types of programs. The mass storage device 112 can also be configured to store other types of programs and data.

The mass storage device 112 is connected to the CPU 102 through a mass storage controller (not shown) connected to the bus 110. The mass storage device 112 and its associated computer readable media provide non-volatile storage for the computer 100. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 800. For purposes of the claims, the phrase “computer storage medium,” and variations thereof, does not include waves or signals per se or communication media.

According to various configurations, the computer 100 can operate in a networked environment using logical connections to remote computers through a network such as the network 120. The computer 100 can connect to the network 120 through a network interface unit 116 connected to the bus 110. It should be appreciated that the network interface unit 116 can also be utilized to connect to other types of networks and remote computer systems. The computer 100 can also include an input/output controller 118 for receiving and processing input from a number of other devices 127, including a keyboard, mouse, touch input, an electronic stylus (not shown in FIG. 8), or a physical sensor such as a video camera. Similarly, the input/output controller 818 can provide output to a display screen or other type of output device 125.

It should be appreciated that the software components described herein, when loaded into the CPU 102 and executed, can transform the CPU 102 and the overall computer 100 from a general-purpose computing device into a special-purpose computing device customized to facilitate the functionality presented herein. The CPU 102 can be constructed from any number of transistors or other discrete circuit elements, which can individually or collectively assume any number of states. More specifically, the CPU 802 can operate as a finite-state machine, in response to executable instructions contained within the software modules disclosed herein. These computer-executable instructions can transform the CPU 102 by specifying how the CPU 102 transitions between states, thereby transforming the transistors or other discrete hardware elements constituting the CPU 102.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 100 in order to store and execute the software components presented herein. It also should be appreciated that the architecture shown in FIG. 1 for the computer 100, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 800 might not include all of the components shown in FIG. 1, can include other components that are not explicitly shown in FIG. 1, or can utilize an architecture completely different than that shown in FIG. 1.

It is appreciated that the network computing environments described in FIG. 8 can comprise a distributed network computing environment in which aspects of the disclosed technologies can be implemented, according to various embodiments presented herein. Illustratively, one or more server computers can be interconnected via a communications network 120 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer, a gaming console, a smart watch, a telephone, such as a smartphone, a personal computer, and an AR/VR device (such devices not being shown in FIG. 1).

In a network environment in which the communications network 120 is the Internet, for example, the server computer can be a dedicated server computer operable to process and communicate data to and from the client computing devices 105 via any of a number of known protocols, such as, hypertext transfer protocol (“HTTP”), file transfer protocol (“FTP”), or simple object access protocol (“SOAP”). Additionally, the networked computing environment can utilize various data security protocols such as secured socket layer (“SSL”) or pretty good privacy (“PGP”). Each of the client computing devices 900B-900G can be equipped with an operating system operable to support one or more computing applications or terminal sessions such as a web browser (not shown in FIG. 1, or other graphical user interface (not shown in FIG. 1), or a mobile desktop environment (not shown in FIG. 1) to gain access to the server computer.

The server computer can be communicatively coupled to other computing environments (not shown in FIG. 1) and receive data regarding a participating user's interactions/resource network. In an illustrative operation, a user (not shown in FIG. 1) may interact with a computing application running on a client computing device to obtain desired data and/or perform other computing applications.

The data and/or computing applications may be stored on one or more of the servers, and communicated to cooperating users through the client computing devices over an exemplary communications network 120. A participating user (not shown in FIG. 1) may request access to specific data and applications housed in whole or in part on the server computer. These data may be communicated between the client computing devices and the server computer for processing and storage.

Furthermore, server computer can operatively host computing applications, processes and applets for the generation, authentication, encryption, and communication of data and applications, and may cooperate with other server computing environments (not shown in FIG. 1), third party service providers (not shown in FIG. 1), network attached storage (“NAS”) and storage area networks (“SAN”) to realize application/data transactions.

It should be appreciated that the computing architecture shown in FIG. 1 and the illustrative distributed network computing environment have been simplified for ease of discussion. It should also be appreciated that the computing architecture and the distributed computing network can include and utilize many more computing components, devices, software programs, networking devices, and other components not specifically described herein.

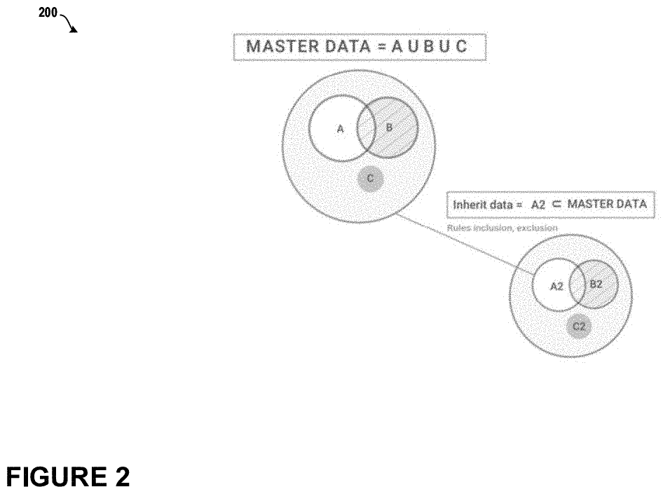

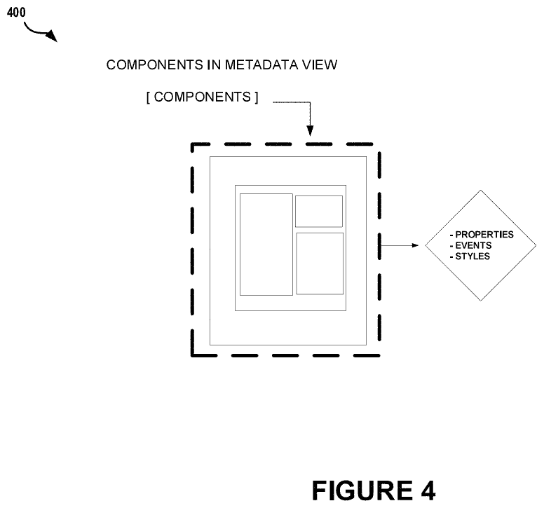

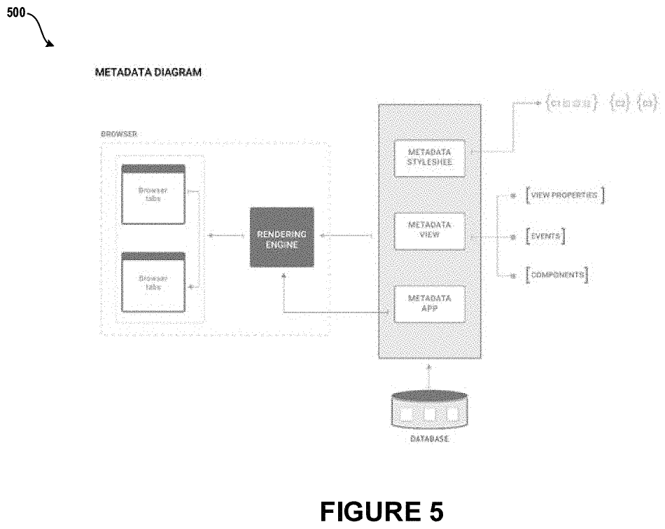

As illustrated in FIGS. 2, 4 and 5, the present invention can be illustratively deployed Meta-data in the context of a configurable computing platform illustratively operable to execute a meta-data model for the non-programmatic development of one or more applications on the illustrative exemplary computing platform. In an illustrative implementation, a common pool of components, as shown, can be provided that can be operatively combined in multiple different ways to provide a common functionality. In the illustrative implementation, a webpage can be treated as a canvas on which there are a set of components which can interact with each other on a function/feature basis. Further, these components can have more components embedded within them. The component type, behavior, events and the messaging between them is supported by the framework and this enables the components to communicate with each other. Further, the components can illustratively operatively cooperate with each through an exemplary Adapater (e.g., webservices) and retrieve data to be displayed to users. Operatively, the interaction between the cooperating components can provide the desired functionality of the application.

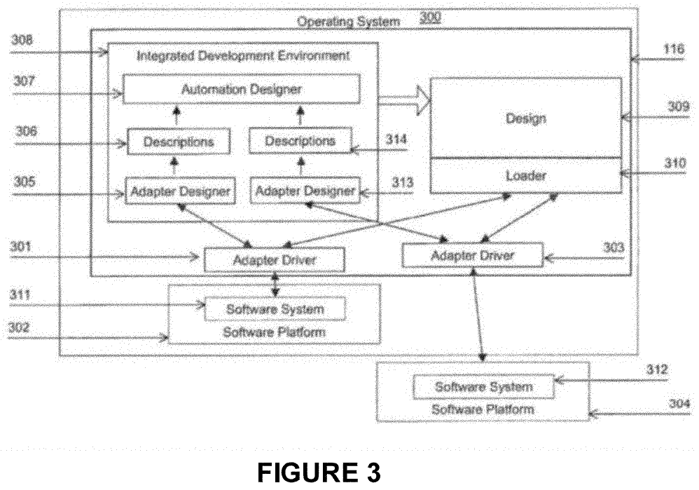

As illustrated in further detail in FIG. 3, the visual software development software package 116 includes a number of elements that operate in the manner described below, under control of a suitable operating system 300, such as MICROSOFT WINDOWS.®. In this operational context, the elements define a system that includes one or more adapters, each comprising an adapter driver 301, 303, etc. and an adapter designer 305, 313, etc. For example, in FIG. 3 a first adapter comprises adapter designer 305 and adapter driver 301, and a second adapter comprises adapter designer 313 and adapter driver 303. As described below in further detail, adapter driver 301 interrogates at least one element of a first software system 311 that is built in accordance with a first platform 312 utilizing the interface of the first platform, and adapter driver 303 interrogates at least one element of a second software system 312 that is build in accordance with a second platform 304 utilizing the interface of the second platform. The adapters generate descriptions 306 and 314 that the user can then incorporate into a design 309. For example, the first adapter can generate descriptions that describe elements of the first software system 311, and the second adapter can generate descriptions that describe elements of the second software system 312. Although two software systems 311 and 312 are illustrated in FIG. 3, any suitable number and type of adapters can be included for interrogating and generating descriptions for any suitable corresponding number and type of software systems. The “type” of software system refers to the platform to which the software system is built in accordance with. For example, MICROSOFT WORD.®, a common word-processing application program, is a software system built in accordance with the MICROSOFT WINDOWS.® platform. Still other software systems may be associated with mainframe computer platforms, such as an IBM mainframe. Note that software systems 311 and 312 can be of disparate platforms. Where software platform 302 is illustrated as existing on the operating system 300 that executes the IDE 308, the software platform 304 is illustrated as outside operating system 300 and thus not compatible with operating system 300.

In view of the teachings in this patent specification, persons skilled in the art will be able to make and use adapters for essentially any software system of essentially any suitable platform. As described below, the adapters can interrogate and otherwise interact with any portion or element of the software system for which the user desires to create a corresponding description. Software systems can include not only application programs but also libraries, objects, controls, applications, and web sites. Each description can describe one or more elements of a software system. The term “element of a software system” refers to any unique instance of a type of software platform functionality contained in the software system. The term “interrogate” refers to utilizing a software platform specifically to discover and identify software systems, to further discover and identify software elements of chosen software systems, and to monitor the ongoing state of the software system and its elements. “Utilizing” a software platform refers to the act of invoking functionality exposed by the software system or platform.

As described in further detail below, the descriptions generated by the adapters can be represented graphically (i.e., displayed on screen 114) for the user with icons under control of an integrated development environment (IDE) 308. Using IDE 308, one can select and interconnect descriptions to build the design 309 and thereby define algorithms in a manner analogous to that in which a circuit designer uses CAD system to interconnect icons representing electronic components.

Thus, each adapter designer 305 and 313 utilizes its corresponding adapter driver 301 and 303, respectively, to expose a visual representation of software system 311. A person can use the adapter designers 305 and 313 to build descriptions 306 and 314, respectively, each of which describes elements of the software system's 311 functionality by capturing the necessary information specific to software platform 302 to identify or otherwise discover the functionality and invoke the functionality during the software system's 311 execution. Each of adapter drivers 301 and 303 comprises software that utilizes software platform (302 and 304, respectively) functionality to carry out of the act of interrogating software systems 311 and 312, respectively, during the building of the design 309, and carries out the requests of the descriptions 306 and 314, respectively, to effect the user-defined algorithms contained within the design 309. The descriptions 306 and 314 comprise software that represents the identity of an instance of a software element and functionality to interact with the instance in response to interconnections using the corresponding adapter driver 301 and 303, respectively, that provided the descriptions.

IDE 308 further includes an automation designer 307 that allows user-defined algorithms to be designed by selecting two or more components from descriptions 306 and graphically creating the interconnections between the selected descriptions 306 such that the control and data flow of the algorithm is captured. Components may be selected from descriptions 306 and descriptions 314 to design a user-defined algorithm that includes functionality from both software system 311 and software system 312.

IDE 308 can include the ability to create user interfaces, such as a Windows Form 402, for its target platform, and may include an adapter designer and adapter driver to its target platform enabling the user interfaces to be included in user-defined algorithms.

IDE 308 produces a design 309 that contains the descriptions and their interactions. A loader 310 loads the descriptions, which in turn load or otherwise establish interaction with the adapter drivers 301, 303 that were utilized in their design. In one embodiment, a loader 310 may be an engine that reads metadata in order to de-serialize one or more functioning object graphs representing the descriptions and their interactions contained within the design 309. Object graphs are known to be hierarchical with a parent object may contain references to child objects, where the child objects may contain references to their own children and so on to an arbitrary level. In another embodiment, a loader 310 may be an executable shell that contains or otherwise links to libraries, object modules, and resources produced by compiling source code representations of the descriptions and their interactions contained within the design 309. In another embodiment, the loader 310 may be a Virtual Machine which reads instruction representations of the descriptions and their interactions contained within the design 309. The loading of the descriptions and interconnections of the design cause the effect of the user-defined algorithms contained within the design 309. Note that at no time during the course of using the adapters to generate the components, using IDE 308 to select and interconnect them to form a design embodying an algorithm, and using loader 310 to effect the algorithm, are any of the original software systems 311 and 312 extended or modified.

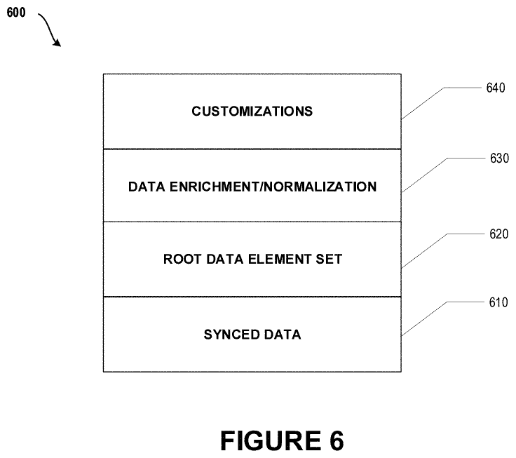

FIG. 6 describes an illustrative data stack 600 operative in an exemplary computing environment of FIG. 1 that illustratively operates a catalog e-commerce application. As is shown exemplary data stack 600 can comprise various data elements including but not limited to synced data 610, root data element set 620, data enrichment/normalization data elements 630, and customizations 640. Illustratively, one or more of the data stack 600 components can be utilized to generate e-commerce catalog data for rendering in illustrative computing environment as is shown in FIG. 1.

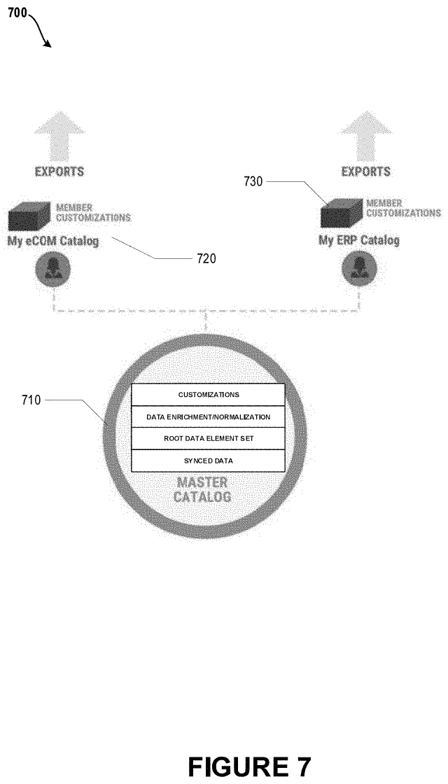

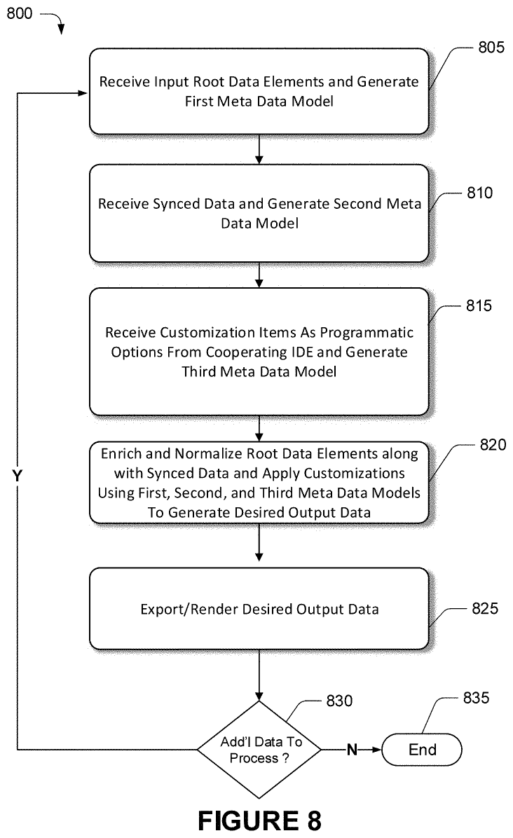

FIG. 7 describes a logical workflow in which, through the visual programming features described in the systems and methods of FIGS. 1-6, and 8, multiple exemplary illustrative catalogs can be generated. In the illustrative operation, logical workflow 700 comprise master catalog 710, that can be processed to generate separate and distinct catalogs 720 and 730. In the illustrative implementation, the separate and distinct catalogs 720 and 730 can comprise a e-commerce catalog that has particular selected product/services data as well as a catalog that identifies those specific products/services that are available in inventory (i.e., Enterprise Resource Planning data). By having the data stack available for use through the exemplary visual programming tool, the exemplary other catalogs 720 and 730 and be expediently generated without having to hard-code separate data instances representative of the other catalogs 720 and 730.

FIG. 8 describes an exemplary method for use in utilizing the illustrative visual programming environments described herein to generate exemplary catalogs for use by an exemplary ecommerce computing platform and other associated exemplary computing environments comprising an ERP system, Customer Relationship Management (CRM) system, accounting systems, and other cooperating exemplary computing environments. As is shown, illustrative method 800 begins at block 805 wherein root data elements are received and first meta data model is generated for use by an illustrative visual programming computing environment. From there, processing proceeds to block 810 wherein synced data is received and a second meta data model is generated for use by the illustrative visual programming computing environment. At block 815, data representative of customization data is received and a third meta data model is generated. The customization data of block 815 can illustrative comprise programmatic options for use in the exemplary visual programming computing environment. The received data of blocks 805, 810, and 815 can then be enriched and normalized using the first, second, and third generated data models. In an illustrative operation, the meta data models are presented in the illustrative visual programming environment for manipulation and interaction to generate one or more instructions to generate selected desired output data such as a particular type of catalog describing various products/services. The processed data of block 820 can then be exported/rendered for subsequent use.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments, including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object-oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A computer implemented method for visual software development implemented in a configurable computer platform having one or more executable modules comprising:
a processor adapted to execute program instructions stored in a memory,
a memory adapted to store program instructions that are executable by the processor, and program instructions stored in the memory and executable by the processor to perform the method comprising:
generating, by at least one adapter, descriptions for one or more computing resources, the one or more computing resources having one or more configuration frameworks to generate meta data, the first adapter being associated with at least one of the one or more configuration frameworks, the at least one adapter interrogating at least one element of the one or more computing resource and generating at least one description corresponding to an element of the one or more computing resources without altering or extending the one or more first computing resources, the at least one description including a set of rules, the at least one adapter having a user interface to initiate interrogation when a new object is created within an element of the one or more computing resources, the at least one adapter interrogating properties of the new object, comparing the properties of the new object against the set of rules of the at least one description to determine whether there is a match, in response to the properties of the new object matching the set of rules, identifying the new object, and in response to the new object being identified, controlling the identified object;
receiving, at a user interface of an integrated development environment (IDE) to build a design using the descriptions, graphically selected descriptions and created interconnections of a design, the design comprising user-selected descriptions and the interconnections between descriptions and graphical icons representing the user selected descriptions and interconnections, the user-selected descriptions and interconnections together defining a user-defined algorithm; and
enabling the user-defined algorithm to be effected in response to the user-selected descriptions and interconnections to generate desired output data from one or more cooperating data sources according to the design.

2. The method of claim 1, further comprising generating a first meta data model representative of root data elements for use when building the design.

3. The method of claim 1, further comprising generating a second meta data model representative of synced data elements for use when building the design.

4. The method of claim 1, further comprising generating a third meta data model representative of customization data elements for use when building the design.

3. The method of claim 3, 4, or 5, further comprising generating output data according to the design using one or more of the first, second, and third meta data models of claims.

5. A visual software development system for use on a configurable computing platform, comprising:
a processor adapted to execute program instructions stored in a memory,
a memory adapted to store program instructions that are executable by the processor, and program instructions stored in the memory and executable by the processor to implement:
at least one adapter adapted to generate descriptions for one or more computing resources, the one or more computing resources having one or more configuration frameworks, the first adapter being associated with at least one of the one or more configuration frameworks, the at least one adapter interrogating at least one element of the one or more computing resource and generating at least one description corresponding to an element of the one or more computing resources without altering or extending the one or more first computing resources, the at least one description including a set of rules, the at least one adapter having a user interface to initiate interrogation when a new object is created within an element of the one or more computing resources, the at least one adapter interrogating properties of the new object, comparing the properties of the new object against the set of rules of the at least one description to determine whether there is a match, in response to the properties of the new object matching the set of rules, identifying the new object, and in response to the new object being identified, controlling the identified object;
receiving, at a user interface of an integrated development environment (IDE) to build a design using the descriptions, graphically selected descriptions and created interconnections of a design, the design comprising user-selected descriptions and the interconnections between descriptions and graphical icons representing the user selected descriptions and interconnections, the user-selected descriptions and interconnections together defining a user-defined algorithm; and
enabling the user-defined algorithm to be effected in response to the user-selected descriptions and interconnections.

6. The visual software development system of claim 2, wherein the first adapter is further adapted to provide a designer having a user interface to select an element of the first software system, to generate the set of rules included in the at least one description for each selected element, the set of rules identifying the selected element, and to create an automation component for each selected element storing the set of rules.

7. The visual software development system of claim 6, wherein each automation component is adapted to expose at least one of properties, methods, and events to be used to manipulate the corresponding element of the first software system.

8. The visual software development system of claim 7, wherein each automation component is further adapted to provide synchronization methods and events to deterministically control the first software system without using timers or other non-deterministic mechanisms.

9. The visual software development system of claim 8, further comprising at least one driver adapted to interact with interfaces of the first software system, to enumerate instances of elements of the first software system, the interfaces of the instances, and the items of the interfaces of the instances.

10. The visual software development system of claim 9, wherein the driver is further adapted to control the first software system, the interaction with the interfaces of the first software system, and the items of the interfaces of the first software system, and to capture events generated by the first software system.

11. A computer-readable storage medium having computer-executable instructions stored thereupon which, when executed by one or more processors of a computing device, cause the one or more processors of the computing device to:
generate, by at least one adapter, descriptions for one or more computing resources, the one or more computing resources having one or more configuration frameworks to generate meta data, the first adapter being associated with at least one of the one or more configuration frameworks, the at least one adapter interrogating at least one element of the one or more computing resource and generating at least one description corresponding to an element of the one or more computing resources without altering or extending the one or more first computing resources, the at least one description including a set of rules, the at least one adapter having a user interface to initiate interrogation when a new object is created within an element of the one or more computing resources, the at least one adapter interrogating properties of the new object, comparing the properties of the new object against the set of rules of the at least one description to determine whether there is a match, in response to the properties of the new object matching the set of rules, identifying the new object, and in response to the new object being identified, controlling the identified object;
receive, at a user interface of an integrated development environment (IDE) to build a design using the descriptions, graphically selected descriptions and created interconnections of a design, the design comprising user-selected descriptions and the interconnections between descriptions and graphical icons representing the user selected descriptions and interconnections, the user-selected descriptions and interconnections together defining a user-defined algorithm; and
enable the user-defined algorithm to be effected in response to the user-selected descriptions and interconnections to generate desired output data from one or more cooperating data sources according to the design.

12. The computer-readable storage medium of claim 11, further comprising instructions to generate a first meta data model representative of root data elements for use when building the design.

13. The computer-readable storage medium of claim 12, further comprising instructions to generate second meta data model representative of synced data elements for use when building the design.

14. The computer-readable storage medium of claim 13, further comprising instructions to generate a third meta data model representative of customization data elements for use when building the design.

15. The computer-readable storage medium of claims 12, 13, and 14, further comprising instructions to generate output data according to the design using one or more of the first, second, and third meta data models.
